(19) United States
(12) Patent Application Publication
(10) Pub. No.: US 2003/0235157 A1
(43) Pub. Date: Dec. 25, 2003

(54) Method and structure for an autoconfiguration topology calculation

(75) Inventors: Richard H. Boivie, Monroe, CT (US); Nancy K. Feldman, New City, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY

(21) Appl. No.: 10/176,043

(22) Filed: Jun. 21, 2002

(51) Int. Cl. H04J 3/14; H04L 12/28

(52) U.S. Cl. 370/254; 370/401

(57) ABSTRACT

A method (and structure) of automatically configuring a network including a plurality of interconnected computers currently on-line, includes determining a current configuration of the network by determining which computers are currently on-line and using the determined current configuration to determine a current network topology that defines a neighborhood relationship for those computers currently on-line.

### CROSS-REFERENCE TO RELATED APPLICATIONS

The present Application is related to the following co-pending applications:

U.S. patent application Ser. No. 10/______, filed on ______, to Boivie et al., entitled “METHOD AND STRUCTURE FOR AUTOCONFIGURATION OF OVERLAY NETWORKS BY AUTOMATIC SELECTION OF A DESIGNATED NETWORK ROUTER”, having IBM Docket YOR920010620US1; and

U.S. patent application Ser. No. 10/______, filed on ______, to Boivie et al., entitled “METHOD AND STRUCTURE FOR AUTOCONFIGURATION OF NETWORK DESTINATIONS”, having IBM Docket YOR920010622US1;

all assigned to the present assignee, and all incorporated herein by reference.

### BACKGROUND OF THE INVENTION

1. Field of the Invention

The present invention generally relates to automatic configuration of a computer network. Specifically, a designated router automatically determines which routers are currently on-line and, based on this information, calculates a periodically-updated network topology, exemplarily using an algorithm to construct a network minimum spanning tree.

2. Description of the Related Art

An overlay network is a “virtual network” that resides on top of another network. This “virtual network” usually needs to be configured, so that the overlay routers know of each other, as well as the destinations within the overlay network. This network configuration process defines a network topology and is typically done manually. Should an overlay router drop off-line, the overlay network can be incapacitated.

Accordingly, what is missing in the conventional art is a method to automatically configure or reconfigure an overlay network. More specific to the present invention, what is missing is a method to easily and automatically calculate an initial network topology, as based upon having determined the current network configuration, and then adjust that topology as the network configuration changes.

### SUMMARY OF THE INVENTION

The first of the above-listed related application, U.S. patent application Ser. No. 10/______, (hereinafter “the designated-router application”), describes a first step in autoconfiguration of an overlay network by providing an exemplary method in which an overlay network can automatically and systematically designate one of the on-line routers to determine and maintain a network topology. The present invention describes a mechanism that could be executed by such a designated network router to perform the duty of calculating a network topology.

In the designated-router application, a method is described in which a criterion is pre-established so that each router capable of performing the role as designated network router can determine whether it should continue to serve in that role. Each router compares itself with other routers currently on-line, using the agreed-upon priority criterion. All routers eventually drop out, except one, which continues to serve as the designated network router.

The primary task of the designated network router is the establishment of the network topology. The present invention describes a method in which a router, having been selected through any process, whether manually or automatically (such as that above briefly summarizing the technique described in the designated-router application) to serve the role herein described as being a designated network router, executes its function of establishing the network topology and then broadcasts this topology to inform each overlay router of the network addresses of the other overlay routers with which it should exchange routing information. Each overlay router then starts exchanging route protocol messages with this one or more neighbors. The method of the present invention additionally allows the designated network router to automatically adjust the network topology as network conditions change. Although the technique described herein is assumed to have been preceded by an automatic selection of a designated network router, this preceding step is not a requirement to practicing various aspects of the present invention.

It is, therefore, an object of the present invention to provide a method and structure to construct a network topology and to update this topology as network conditions change.

It is another object of the present invention to provide an exemplary method of calculating a network topology by constructing a minimum spanning tree.

In order to achieve the above goals and objectives, in a first aspect of the present invention, described herein is a method (and structure) of automatically configuring a network including a plurality of interconnected computers currently on-line. The method includes determining a current configuration of the network by determining which of these computers are currently on-line, and using the determined current configuration to determine a current network topology that defines a neighborhood relationship for those units currently on-line.

In a second aspect of the present invention, also described herein is a network capable of executing an adaptive autoconfiguration process, including a plurality of computers, a plurality of communication linkages interconnecting the plurality of computers, wherein any number of the plurality of computers may be on-line at any one time. The network includes a method to determine a current network topology as based on having determined which of the plurality of computers are currently on-line, the current network topology defining a neighborhood relationship for those computers currently on-line.

In a third aspect of the present invention, also described herein is a signal-bearing medium tangibly embodying a program of machine-readable instructions executable by a digital processing apparatus to perform the above-described method.

In a fourth aspect of the present invention, also described herein is a method of calculating a routing topology for a network including a plurality of N interconnected computers, each computer including a node N₁ in the network. The method includes determining current distances between ones of the plurality of computers currently on-line and constructing a minimum spanning tree from these current distances.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows a simplistic exemplary overlay network;

FIG. 2A is a flowchart of a basic technique 200 of the present invention in which the designated network router calculates a network topology and then updates that topology as network conditions change;

FIG. 2B is a flowchart of an exemplary embodiment in which the designated network router has been selected as being the router having the lowest identification number currently on-line and the topology is calculated by constructing a network minimum spanning tree using distance information received from the non-selected routers;

FIG. 2C is a flowchart of an exemplary embodiment that can be used to calculate a network minimum spanning tree;

FIG. 3 illustrates an exemplary hardware/information handling system 300 for incorporating the present invention therein; and

FIG. 4 illustrates a signal bearing medium 400 (e.g., storage medium) for storing steps of a program of a method according to the present invention.

### DETAILED DESCRIPTION OF A PREFERRED EMBODIMENT OF THE INVENTION

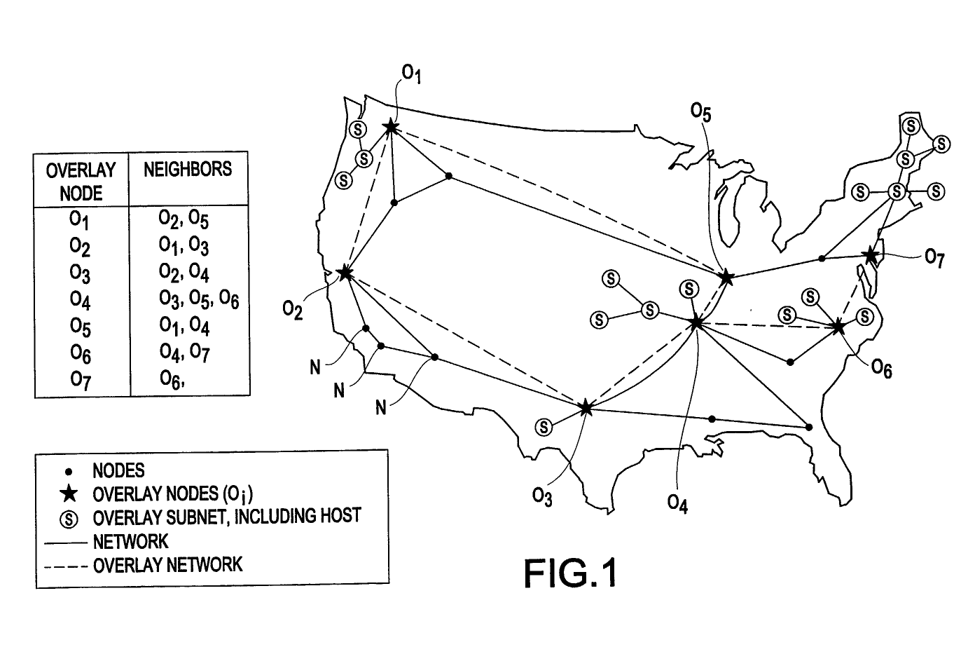

Referring now to the drawings, and more particularly FIG. 1 in which is shown a simplistic exemplary overlay network having routers O₁-O₇ and destination subnets S. A network (solid lines) interconnects a plurality of nodes N. The overlay network (dotted lines) consists of only certain nodes of the network, shown in FIG. 1 as the overlay router nodes O₁. Network destinations, i.e., Internet Provider (IP) subnets S, are also shown on the figure. Each subnet would typically have an associated host/server computer (not shown), which is the contact to that subnet form the overlay network.

In a preferred exemplary embodiment of the network autoconfiguration techniques that include the present invention and that provides maximum flexibility for the overlay network, each overlay network router O₁ is configured so that it is capable to serve as the designated network router. Although not illustrated in FIG. 1, it is noted that the network could be partitioned. If so partitioned, there would be several designated routers, i.e., one in each of the disconnected partitions of the network.

If the network shown in FIG. 1 has been established using the autoconfiguration technique described in the designated router application, it is assumed in this discussion that a selection criterion for determining which potential network router fulfills the role as designated network router has already been executed, and that one router is left with the task of calculating a network topology. However, it should be obvious that the present invention can be used in any network in which a computer has the task of establishing the neighborhood relationships for elements of the network, even if such computer is manually designated or even if only one such computer exists on the network.

Therefore, the term “designated network router”, as carried forward in the present description from the terminology of the designated-router application, does not carry the same connotation in this discussion as necessarily being a computer having been selected from various computers configured to potentially fulfill this role. In this discussion a “designated network router” is simply any computer having the task of establishing a network topology, i.e., establishing the neighborhood relationships between various elements of a network. Additionally, similar terminology such as “non-selected router” merely means elements of the network that do not have the task of establishing the topology.

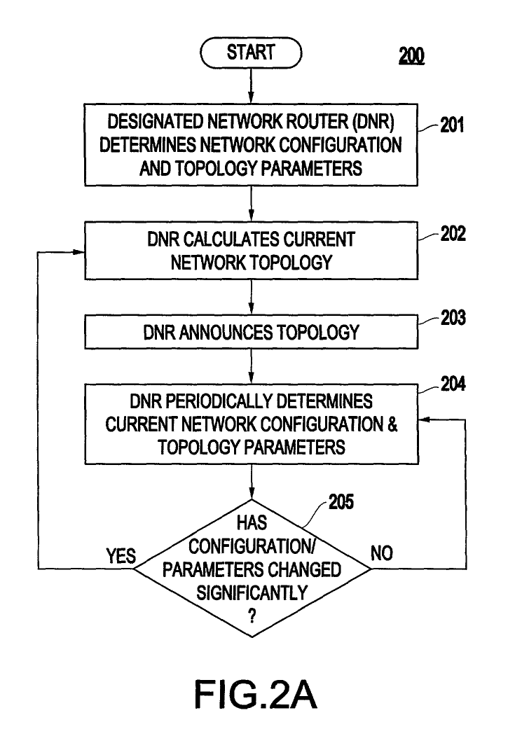

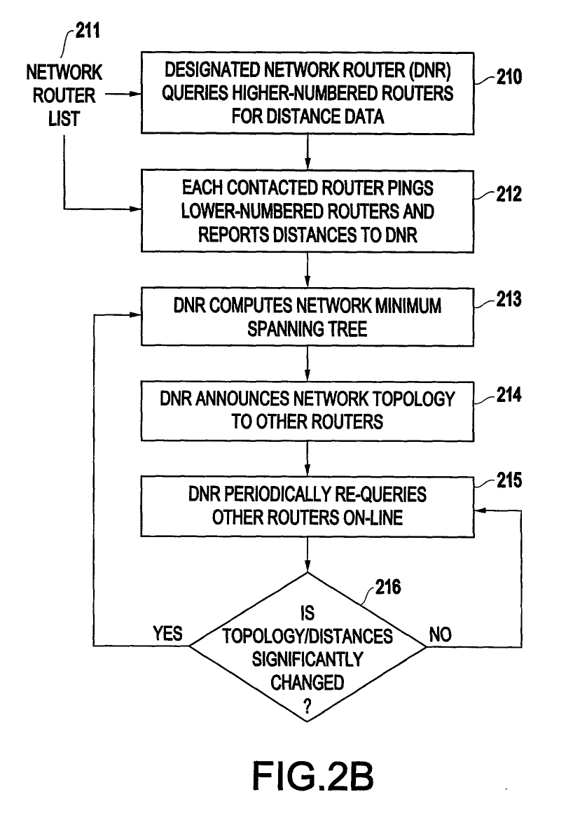

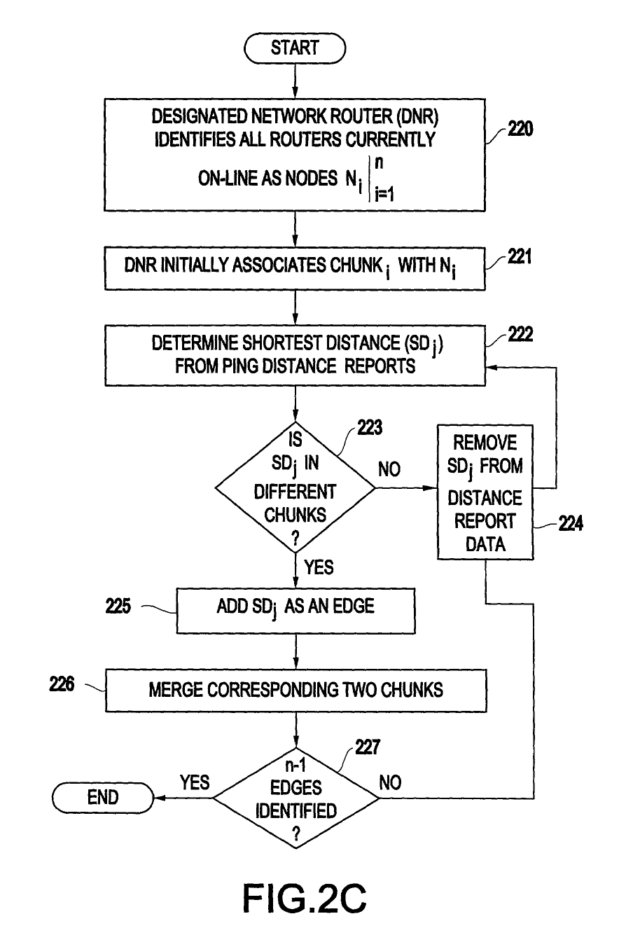

FIG. 2A shows how the designated network router proceeds in step 201 to determine which of the non-selected routers are currently on-line and any other parameters and data needed to perform in step 202 the calculations for the network topology. Any of various methods could be used in these two steps, as long as the method allows an identification of computers currently on-line and a way to assign neighbor relationships for routing throughout the network.

That is to say, the current network configuration could be determined in step 201 by simply having the designated network router send out a query for on-line units to announce their presence, and the topology calculation in step 202 could be as simple as merely consulting a predefined listing of neighbor relationships. A variation would be that each on-line unit announces its presence at least once in every pre-established time interval even if that unit has no other network activity during that time, thereby permitting the designated network router to recognize that unit's presence and include it in a current topology.

Regardless of the technique to determine the current network topology, in step 203 the designated network router broadcasts the topology defining the neighbor relationships to the entire network. In order to adapt to network changes, in step 204, the designated network router periodically determines current configuration and parameters and, in step 205, determines whether the topology needs to be re-determined and re-broadcast to the network.

Alternatively, a more sophisticated method may provide greater network efficiency by being able to select any of the potential designated network routers and by taking into account an actual distance between on-line routers as measured to reflect which intercommunication linkages are currently available, which linkages are noisy or too busy, etc.

Thus, in an exemplary preferred embodiment shown in FIG. 2B, the designated network router is assumed to be the router having the lowest identification number of all routers currently on-line and the topology is exemplarily calculated by constructing a minimum spanning tree, as based on having actually measured the distances between on-line routers. In step 210, since the designated router is presumed as being the lowest-numbered router, it attempts to establish TCP (Transmission Control Protocol) connections to any higher-numbered routers currently on-line to query each of these routers to provide distance between it and all other routers.

It is noted that any communication method or protocol can be used for intercommunication. Thus, while TCP is a preferred method of establishing the connection because of its reliability, other data transmission methods may be used instead.

The designated router is able to communicate to the other routers by consulting a network router list 211. That is, exemplarily, each overlay router O₁ including the designated router, receives a complete list 211 of the IP (Internet Protocol) addresses of all other overlay routers potentially on-line. The exact mechanism for providing the IP addresses to the routers is not important since any number of well known techniques could be used.

As shown in step 212, in response to this query, each router will ping all routers having lower IP addresses than it does and sends this information to the designated router. Thus, it is not necessary that each router ping every other router since it is assumed the round-trip distance from a to b is equal to the round-trip distance from b to a. Step 212 inherently minimizes the pinging by exemplarily having only lower-numbered routers pinged.

It is also noted that, although pinging is the preferred method for determining distances, other methods may be used, and distance measurements other than milliseconds may be used. Additionally, although this discussion assumes that the code implementing this embodiment of the present invention is optimized so that all routers do not need to ping each other, this optimization is not a requirement and it could be implemented in various ways. That is, pinging only lower-numbered routers saves time but an alternative might be the pinging of only higher-numbered routers.

As shown in step 213, having received this distance information, the designated router now computes a network minimum spanning tree using an exemplary technique to be shortly discussed. In step 214, the designated router tells each of the other routers its neighbors in the minimum spanning tree. These neighbors are the nodes with which it should communicate within the routing protocol. In order to adapt to network changes, in step 215, the designated router periodically sends out queries again to the on-line routers to update network membership and distances.

When the designated router receives new distance information it will compute a new minimum spanning tree. In many cases, the “new” tree will be identical to the old tree but in some cases the new tree may be different, either because routers have been added or deleted or because distances have changed as a result of router interconnection disruptions. In step 216, if topology or distance data is significantly different as resulting from a re-query, the designated network router will calculate a new minimum spanning tree to announce new neighbor relationships to any nodes that have a new set of neighbors.

Note, as shown in step 216, that it might make sense to avoid unnecessary “churning” and only replace the minimum spanning tree when the new minimum spanning tree is better or significantly better than the existing one. One tree might be defined to be significantly better than another if “the longest path” (i.e., the distance between the two nodes that are farthest apart) in the first tree is, for example, 60 milliseconds shorter than the longest path in the second tree. When an overlay router learns that its list of neighbors has changed, the router revises the set of overlay routers to which it sends its route protocol messages. This is all the overlay router has to do. The standard route protocol mechanisms for updating the route table and timing out ‘old’ route table entries will adjust the route table appropriately. For example, if a router has not heard from a neighbor for some determined period of time, it marks the routes through that neighbor as being unreachable.

### Exemplary Calculation Process for a Network Minimum Spanning Tree

If minimum spanning tree is used for determining network topology, it can be calculated using any of a number of ways. One possible technique is described below and shown in the exemplary flowchart of FIG. 2C.

First, the designated router will start with a graph that has one node for each of the routers and no edges. Then “short edges” will be added to the graph until the graph is connected. As the tree is built, the designated router will keep track of the distinct, disconnected pieces of the graph. The process could work as explained hereinbelow.

As shown in steps 220 and 221 of FIG. 2C, a one-dimensional array of length n is used to keep track of the “chunk” that a node is in. Initially, before any edges are added to the graph, chunk[i] =i, for all i. In other words, each node is in its own chunk.

In steps 222 through 227, edges are then added between nodes, starting with the shortest distances that were determined in the pings above (see step 222), but an edge will only be added if the nodes at each end of the edge are in different chunks (step 223).

If the ends of an edge are in different chunks, as shown in step 225, the edge is added to the graph. In step 226, the two chunks are merged into one larger chunk by changing the chunk numbers of all the nodes that were in the higher-numbered chunk to the chunk number of the lower-numbered chunk. Finally, in step 227, the process continues to add edges until n-1 edges have been added, at which point the n nodes in the graph will all be connected together in a single chunk.

It is noted that more than n-1 edges could be added to spanning tree to provide additional efficiency. For example, as shown in FIG. 1, and assuming that the overlay network O₁-O₇ is configured per the above minimum spanning tree technique, an edge between O₁ and O₅ might advantageously be added, even though six edges would provide a minimum spanning.

Adding Redundancy

If redundant edges are added to the minimum spanning tree, the system will be able to recover faster from changes within the network such as computers dropping off-line. To expand the minimum spanning tree to add additional redundant edges, the next shortest path of the paths as previously determined is found. An additional edge is added to the overlay network corresponding to that path if the addition of this edge would reduce the number of overlay routers that can partition the network. When this edge is added, it is added with an artificially high metric so that this edge will not be used under “normal” circumstances, i.e., it will not be used unless the network would otherwise be partitioned. For example, one technique could be a multiplication (n* its metric) where n is the number of overlay routers in the overlay network.

Exemplary Hardware Implementation

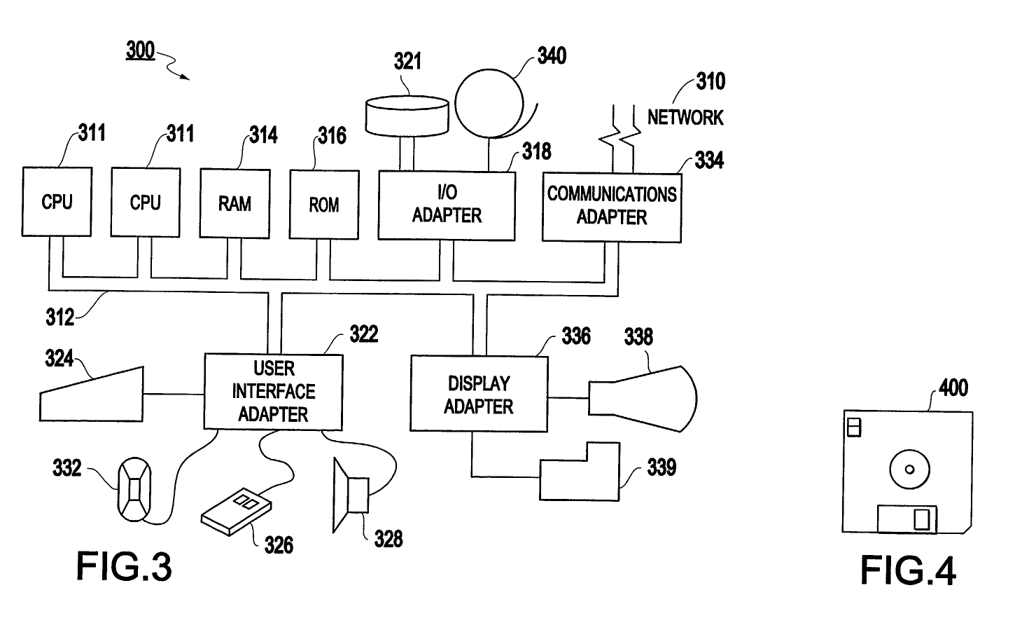

FIG. 3 illustrates a typical hardware configuration of an information handling/computer system 300 that could be used (e.g., as a router) to embody the present invention. The computer system 300 may be interconnected to other routers through network linkage 310 and which preferably has at least one processor or central processing unit (CPU) 311.

The CPUs 311 are interconnected via a system bus 312 to a random access memory (RAM) 314, read-only memory (ROM) 316, input/output (I/O) adapter 318 (for connecting peripheral devices such as disk units 321 and tape drives 340 to the bus 312), user interface adapter 322 (for connecting a keyboard 324, mouse 326, speaker 328, microphone 332, and/or other user interface device to the bus 312), a communication adapter 334 for connecting an information handling system to a data processing network, the Internet, an Intranet, a personal area network (PAN), etc., and a display adapter 336 for connecting the bus 312 to a display device 338 and/or printer 339 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 311 and hardware above, to perform the method of the invention.

This signal-bearing media may include, for example, a RAM contained within the CPU 311, as represented by the fast-access storage for example. Alternatively, the instructions may be contained in another signal-bearing media, such as a magnetic data storage diskette 400 (FIG. 4), directly or indirectly accessible by the CPU 311.

Whether contained in the diskette 400, the computer/CPU 311, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital or analog wireline or wireless communication links. In an illustrative embodiment of the invention, the machine-readable instructions may comprise software object code. It should also be obvious that the instructions of the present invention can also be downloaded to the various network routers via the network input to that router.

While the invention has been described in terms of a single preferred embodiment, those skilled in the art will recognize that the invention can be practiced with modification within the spirit and scope of the appended claims.

Having thus described our invention, what we claim as new and desire to secure by letters patent is as follows:

1. A method of automatically configuring a network, said network comprising a plurality of interconnected computers currently on-line, said method comprising:
determining a current configuration of said network by determining which said interconnected computers are currently on-line; and
using said determined current configuration to determine a current network topology, said network topology defining a neighborhood relationship for said currently on-line units.

2. The method of claim 1, wherein one of said computers currently on-line is variably designated to execute said determining a current network configuration and determining said current network topology.

3. The method of claim 1, wherein said network topology is based on a distance separating said computers currently on-line and determining said network topology comprises constructing a minimum spanning tree for said computers currently on-line.

4. The method of claim 3, wherein for a network currently comprising N on-line computers, said constructing a minimum spanning tree comprises:
selecting at least N-1 of said current distances representing distances between said N nodes to be edges Ej, wherein said selecting of current distances systematically begins at a smallest value of said current distances and selects additional distances as edges from smallest to largest such that an edge is selected if it results in a smaller number of disconnected collections of nodes.

5. The method of claim 2, further comprising:
in each said non-designated computer currently on-line, providing said designated computer a distance information that reports a current distance between said non-designated computer and other computers currently on-line in said network.

6. The method of claim 5, wherein each said non-designated computer provides said distance information in response to a query from said designated computer, said method further comprising:
transmitting, from said designated computer, a query to each said non-designated computer currently on-line to request said distance report; and
receiving, in each said non-designated computer currently on-line, said query and responding with said current distance.

7. The method of claim 6, further comprising:
in each said non-designated computer currently on-line, transmitting a ping to computers on said network to obtain said distance information.

8. The method of claim 7, wherein said pinging is transmitted only to selected ones of said computers currently on-line in said network.

9. The method of claim 8, wherein said selected ones of said computers currently on-line are determined by a relative comparison of identification numbers.

10. The method of claim 1, further comprising:
periodically determining a current configuration of said network so that said current network topology can be updated for significant network changes.

11. The method of claim 3, wherein said network topology includes at least one redundant neighbor relationship.

12. A computer capable of automatically configuring a network, said network comprising a plurality of interconnected computers, said computer comprising:
a communications module for determining a current network configuration being those interconnected computers currently on-line in said network; and
a calculator for determining a current network topology based on said current network configuration, said current network topology defining a neighborhood relationship between all said plurality of interconnected computers currently on-line.

13. The computer of claim 12, wherein said calculator constructs a minimum spanning tree based on distances reported by said computers currently on-line in said network.

14. A network capable of executing an adaptive autoconfiguration process, said network comprising:
a plurality of computers;
a plurality of communication linkages interconnecting said plurality of computers, wherein any number of said plurality of computers may be on-line at any one time; and
a calculator to determine a current network topology based on having determined which of said plurality of computers are currently on-line, said current network topology defining a neighborhood relationship for said computers currently on-line.

15. The network of claim 14, wherein said current network topology comprises a minimum spanning tree for said network, based on a distance currently separating said computers currently on-line.

16. A signal-bearing medium tangibly embodying a program of machine-readable instructions executable by a digital processing apparatus to perform a method of automatically configuring a network, said network comprising a plurality of interconnected computers currently on-line, said method comprising:
determining a current configuration of said network by determining which computers are currently on-line; and
using said determined current configuration to determine a current network topology, said network topology defining a neighborhood relationship for said currently on-line computers.

17. The signal-bearing medium of claim 16, wherein one of said computers currently on-line is variably designated to execute said determining a current network configuration and determining said current network topology.

18. The signal-bearing medium of claim 16, wherein said network topology is based on a distance separating computers currently on-line and determining said network topology comprises constructing a minimum spanning tree for said units currently on-line.

19. The signal-bearing medium of claim 16, wherein said method further comprises:
periodically determining a current configuration of said network so that said current network topology can be updated for significant network changes.

20. A method of calculating a routing topology for a network, said network comprising a plurality of N interconnected computers, each said computer comprising a node N₁ in said network, said method comprising:
determining current distances between ones of said plurality of computers; and
constructing a minimum spanning tree from said current distances.
